(19) United States
(12) Patent Application Publication
(10) Pub. No.: US 2005/0050113 A1
(43) Pub. Date: Mar. 3, 2005

(54) System and method for facilitating data flow between synchronous and asynchronous processes

(75) Inventors: David Wayne Moore, Morgan Hill, CA (US); Frederick Stephen Perry, San Jose, CA (US); Andre du Toit Schoeman, Houston, TX (US)

Correspondence Address: SAMUEL A. KASSATLY LAW OFFICE, 20690 VIEW OAKS WAY, SAN JOSE, CA, 95120, US

(73) Assignee: International Business Machines Corporation, Armonk, NY (US)

(21) Appl. No.: 10/646,182

(22) Filed: Aug. 21, 2003

(51) Int. Cl. G06F 12/00

(52) U.S. Cl. 707/204

(57) ABSTRACT

An intermediate queuing/de-queuing mechanism between an asynchronous server and a synchronous process or client allows the asynchronous server to communicate with the synchronous client in a performance oriented and asynchronous manner. The coexistence of two different queuing mechanisms within the same logical execution environment is thus enabled. Further, the asynchronous merging of other format updates during the recovery process is facilitated, such as change accumulation and image copy records. Operations between the synchronous process and asynchronous processes are thus expedited, embedding a synchronous process within the total asynchronous environment of the overall data processing system to enable restoration of the database.

### FIELD OF THE INVENTION

The present invention generally relates to data storage on computer systems, and more particularly to systems for backing up and recovering physically or logically damaged resources on that data storage. Specifically, this invention relates to a method for managing input and output buffers to facilitate communication between synchronous and asynchronous processes.

### BACKGROUND OF THE INVENTION

A data processing system such as a relational database that handles a large amount of data typically requires a data sorting process that operates while a program such as an application or database process is being processed. These data processing systems are commonly used by financial companies.

During operation, the database system records data in backup copies and backup logs. In the event of a failure, for example, the user wishes to bring the database up to date using the backup copy and backup logs. In the process of backup, the data processing recovery system reads concurrently written logs that are potentially from more than one IMS (Information Management Subsystem).

The data is fed to one particular address space by a task that does nothing but read in the log data sets. While the data records on the backup logs are in time sequence on each log, the data may not be in time sequence when received by the database because the records are arriving from several different sources. Consequently, the data processing system should apply these records in time sequence order.

The sort program is a synchronous process. Consequently, when the sort process starts it should complete its handling a record before the data processing system can supply more data to the sort process. A synchronous process synchronizes its work with its external environment by waiting for external events. However, the recovery environment in which this sort process operates is asynchronous. The outside environment is shipping data asynchronously to the sort processing workspace. Elements are placed on a queue and at some point in time a server removes those items from the queue, processes them, and posts the results to the tasks that originally posted the data.

In an asynchronous environment, there is no guarantee that the data on queue will be processed off the queue in the same order they were placed on the queue. The server and the process that queued the data simply “shake hands” each time they either post an item to the server or the server completes an item indicating that the process has finished. Meanwhile, both the server and the posting task continue to process.

In a system in which system supplied sub-tasks are driven with asynchronous request services, a synchronous sub-task, such as SORT, is required to process requests from the asynchronous services. The synchronous sub-task is not able to coordinate request processing with the asynchronous sub-tasks in the system with the services provided by the system. The synchronous sub-task has two processes, called the input exit and the output exit, neither of which can directly process asynchronous requests. Requests needing to be passed to either process cannot be handled directly using system request services.

During the input phase, the synchronous sub-task can therefore not receive data directly from the asynchronous sub-tasks. To facilitate communication between the two sub-tasks, an intermediary queuing/de-queuing mechanism is required to facilitate asynchronous buffer queuing between the two tasks. During the output phase, the synchronous sub-task provides data needing to be asynchronously merged with data from other asynchronous sub-tasks and the storage use for communication returned to the output process.

For example, a database recovery system has update records that are supplied asynchronously to a synchronous SORT sub-task. The supplying sub-task cannot directly use system asynchronous request services to queue requests containing the data to be sorted to the sort sub-task input exit. This is because the input exit of the sort sub-task is driven by the sort sub-task to obtain data for sort processing. It cannot be driven by the asynchronous system services since it is driven directly by sort. However, the sort input exit requires accessibility to the data from the asynchronous sub-tasks to provide it to sort for processing.

In addition, once the records have been sorted, this sort process is synchronously producing records in sequence. Those records now have to be enqueued to another asynchronous process that is restoring the database and performing each data set recovery operation. Within the database recovery system, update records are sorted and processed by asynchronous sub-tasks.

The sort output exit is driven by sort whenever an update record has completed the sort process. The output exit copies the update record to a buffer and sends the buffer to the asynchronous sub-tasks. The output exit returns control to sort to obtain the next sorted update record. The asynchronous sub-task processes the update record in the buffer and needs to return the record storage to the output exit so that the output exit can use it to store subsequent update records. However, there is no mechanism for returning the buffer using the services available to the asynchronous sub-task returning the buffer.

Typically, data is supplied a synchronous sub-task, such as sort as described above, via the following process: sort calls the input exit synchronously and the input exit calls an access method or synchronous process to obtain the required data. Similarly, data is supplied to processes outside the sort sub-task via the following process: sort calls the output exit synchronously with sorted data and the output exit calls an access method or synchronous process to store the supplied data.

In conventional data processing systems, there is a mismatch between the asynchronous environment and the synchronous sort process relating to the processing of sorted hierarchical database update log records. Data flow should occur between two known sets of code, but with different handshake protocols. The one set of code is a sort processor with serialized input and output phased protocol, whereas the second set of code is a support sub-system with queuing protocol. Once the sort process is completed on a data set, these sorted hierarchical database update log records should be merged asynchronously with other update records of a different format.

Conventional systems invoke the sort processor, but only using the serialized input/output phased protocol. Many database restore/recover utilities that use multiple format records to restore the database, but this is done in a serialized fashion, where only one update record is processed at a time. This increases the elapsed processing time of the database restore/recover utilities.

What is therefore needed is a system and an associated method for allowing the asynchronous process to provide data to and receiving data from the synchronous process without interruption of processing by either the asynchronous process or the synchronous process. The need for such system and method has heretofore remained unsatisfied.

### SUMMARY OF THE INVENTION

The present invention satisfies this need, and presents a system, a computer program product, a service, and an associated method (collectively referred to herein as “the system” or “the present system”) for facilitating data flow between synchronous and asynchronous processes. The asynchronous process sends a request to an intermediate buffer manager and the buffer manager then interfaces with the synchronous sort output process.

The present system provides an intermediate queuing/de-queuing mechanism between an asynchronous server and a synchronous process or client allows the asynchronous server to communicate with the synchronous client in a performance oriented and asynchronous manner. The present system also facilitates the coexistence of the two different queuing mechanisms within the same logical execution environment. Further, the present system facilitates asynchronous merging of other format updates during the recovery process, such as Change Accumulation and Image Copy records.

The present system packages log records into buffers and transfers them in groups to different processing regions in the data processing system. More than one address space is processing these log records so the present system has to distribute the log records the correct address space. The present system facilitates operations between the synchronous process and asynchronous processes, embedding a synchronous process within the total asynchronous environment of the overall data processing system to enable restoration of the database.

Although the present system has been described herein in connection with a sort task, as an example of a synchronous process, the synchronous process could be any prepackaged software package that runs as a simple synchronous process, such as a file update or a select process. In addition, the records that are processed by the present system are not necessarily returned to the originating task.

Furthermore, the records are not passed serially, one at a time, across from the master task to the sort task. Rather, they are queued up asynchronously by the master task working at a rate of speed that is unaffected by the rate at which they can be accepted by the synchronous process (sort). Similarly, as the records are passed from the sort task, they are placed into buffers at a rate that is independent of the rate at which they can be handled, and processed by yet another asynchronous task in the same address space.

As a result, the present system is not limited to the sort being the synchronous process, but allows, for example, a software product to be written with the efficiencies of queuing of asynchronous work elements and still embed a synchronous process within. The synchronous nature of the embedded process is thus not propagated to force other components of the system to follow synchronous protocols.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a system and method for facilitating data flow between synchronous and asynchronous processes of the present invention can be used; and

FIG. 2 is a schematic illustration of a subordinate address space of the system of FIG. 1;

FIG. 3 is a process flow chart illustrating a method of initializing and terminating the process of the system of FIG. 1;

FIG. 4 is a process flow chart illustrating a method of processing input data buffers to the system of FIG. 1; and

FIG. 5 is comprised of FIGS. 5A and 5B and represents a process flow chart illustrating a method of processing output data buffers from the system of FIG. 1.

### DETAILED DESCRIPTION OF PREFERRED EMBODIMENTS

The following definitions and explanations provide background information pertaining to the technical field of the present invention, and are intended to facilitate the understanding of the present invention without limiting its scope:

Asynchronous: Two processes are asynchronous when the driving process requires a function be performed by the receiving process but does not need to wait for the receiving process to complete the function before the driving process continues.

Synchronous: Two processes are synchronous when the driving process requires a function be performed by the receiving process and must wait for the receiving process to complete the function before the driving process continues.

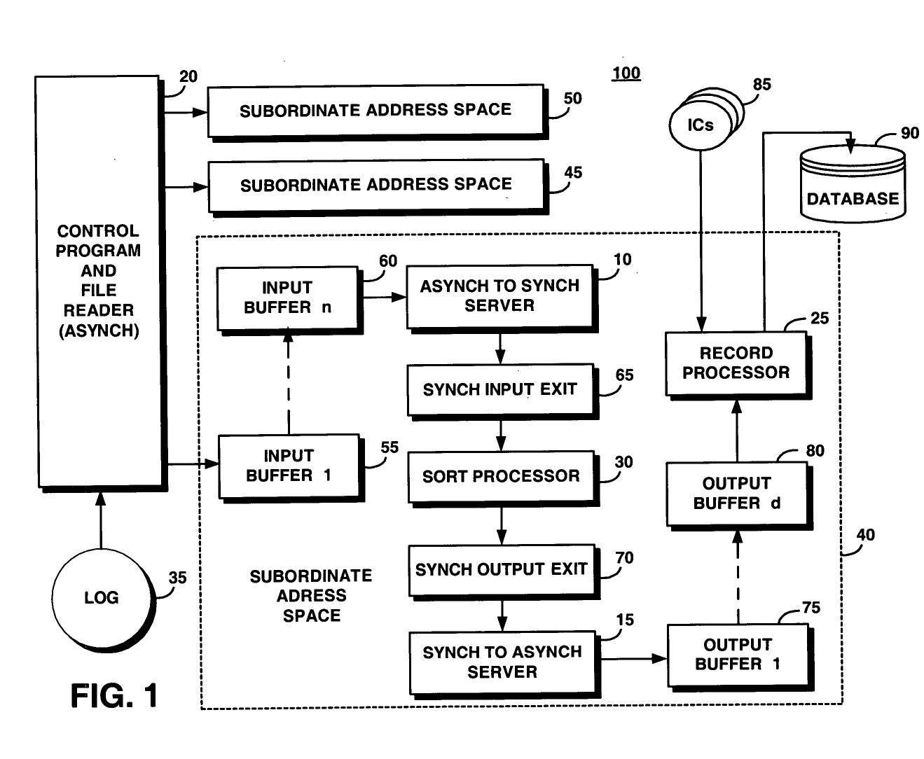

FIG. 1 illustrates an exemplary high-level architecture of a data recovery system 100 comprising an asynchronous to synchronous server 10 (A/S server 10) and a synchronous to asynchronous server 15 (S/A server 15). The A/S server 10 and S/A server 15 facilitate data flow between the asynchronous control program and file reader 20 and record processor 25 and a synchronous process such as, for example, a synchronous sort processor 30. A/S server 10 and S/A server 15 include a software programming code or computer program product that is typically embedded within, or installed on a computer. Alternatively, A/S server 10 and S/A server 15 can be saved on a suitable storage medium such as a diskette, a CD, a hard drive, or like devices.

The asynchronous control program and file reader 20 reads data from the log 35 and communicates asynchronously with one or a plurality of subordinate address spaces such as subordinate address space 40, 45, 50. The log 35 is an accumulation of updates that were made by the database engine (not shown). The asynchronous control program and file reader 20 drives the reading process that manages the transfer of log records: taking logs, making minor modifications, log record in, log record out, etc. In addition, the asynchronous control program and file reader 20 designates to which subordinate address space 40, 45, 50 the log records may be routed. The process of the asynchronous control program and file reader 20 operates asynchronously yet has to provide synchronous input to the sort processor 30.

The log records are transmitted to buffers such as input buffers 55, 60 in an asynchronous manner as they are processed. As represented in FIG. 1, multiple input buffers 55, 60 may be used. The log records are fed to the input buffers 55, 60 at whatever rate the A/S server 10 may accept them. The A/S server 10 determines the speed at which the log records can be processed, making it an asynchronous process. The control program and file reader 20 is not required to wait for processing log records; rather, it continues to read and push processed log records across the interface into the subordinate address space 40, 45, 50.

The A/S server 10 services each request for data buffer management. The A/S server 10 handles the asynchronous request coming from the control program and file reader 20 and then the A/S server 10 supplies data synchronously to the synchronous process, for example, a synchronous sort processor 30. The synchronous input exit 65, sort processor 30, and synchronous output exit 70 are all standard, known technologies. Any suitable synchronous process, such as writing data to a file or database where the driving process operates in a synchronous fashion, could be managed by system 10.

The synchronous input exit 65 provides the means whereby records are passed through a programming interface rather than having the sort processor 30 read them from a data set. Consequently, the sort process is controlled by the subordinate address space 40 in accepting data that is passed by a program unit rather than reading data directly.

The sorting processor 30 outputs the records in sorted sequence one record at a time. These records are typically sorted, for example, by database identifier, the key of the record it applies to in the database, the recovery scope number, and timestamp. The synchronous output exit 70 receives these records one by one from the sort processor 30 and places them sequentially in a buffer such as output buffer 75, 80. As represented in FIG. 1, multiple output buffers 75, 80 may be used.

The record processor 25 reads the image copies (ICs) 85 which are the backup copy of the data, receives the log records from the output buffer 75, 80, and combines them in the right order and writes them to the database 90.

The S/A server 15 continues to fill up output buffers 75, 80 until the output buffer 75, 80 is full. The output buffers 75, 80 are then passed in response to an asynchronous request to the record processor 25. The record processor 25 just posts an entry and requesting another output buffer 75, 80 when data is needed by the record processor 25. The request from the record processor 25 is asynchronous because the record processor 25 simply places the request by placing an element on a queue requesting a buffer and then continues with other processing until the output buffer 75, 80 is provided. The record processor 25 is not only obtaining log data from output buffer 75, 80, it is also reading ICs 85. The record processor 25 makes synchronous requests to get the ICs 85 and then makes asynchronous requests to get log data from output buffer 75, 80.

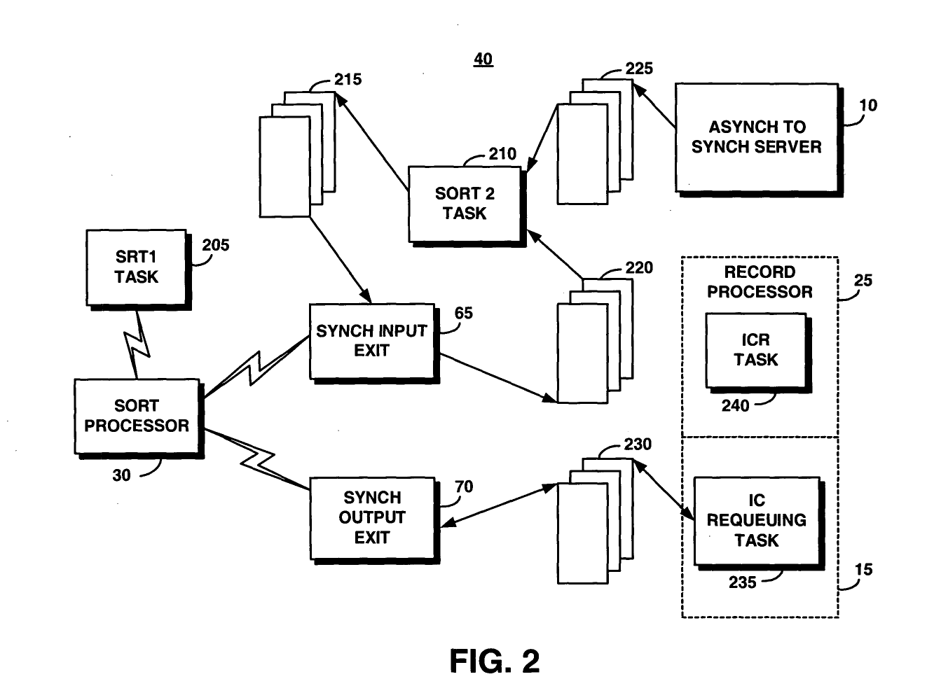

A subordinate address space 40 is shown in more detail in the block diagram of FIG. 2. A management task, SRT1 task 205, is attached to oversee the start and stop of the sort processor 30. SRT2 task 210 manages the asynchronous enqueue and dequeue buffering functions Buffer queues are used to interface between asynchronous and synchronous operation: a private buffer queue 215 and an empty buffer return queue 220. Input buffers 55, 60 are placed in an asynchronous buffer queue 225. Output buffers 75, 80 are placed in an output buffer queue 230. The asynchronous to synchronous server 10 place incoming data buffers on the asynchronous buffer queue 225. The synchronous output exit 70 places buffers on an output buffer queue 230. The image copy (IC) restore requeuer 235 (also referenced as REQ 235) of the synchronous to asynchronous server 15 accepts synchronous buffers from the synchronous output exit and saves them for the image copy restore (ICR) task 240.

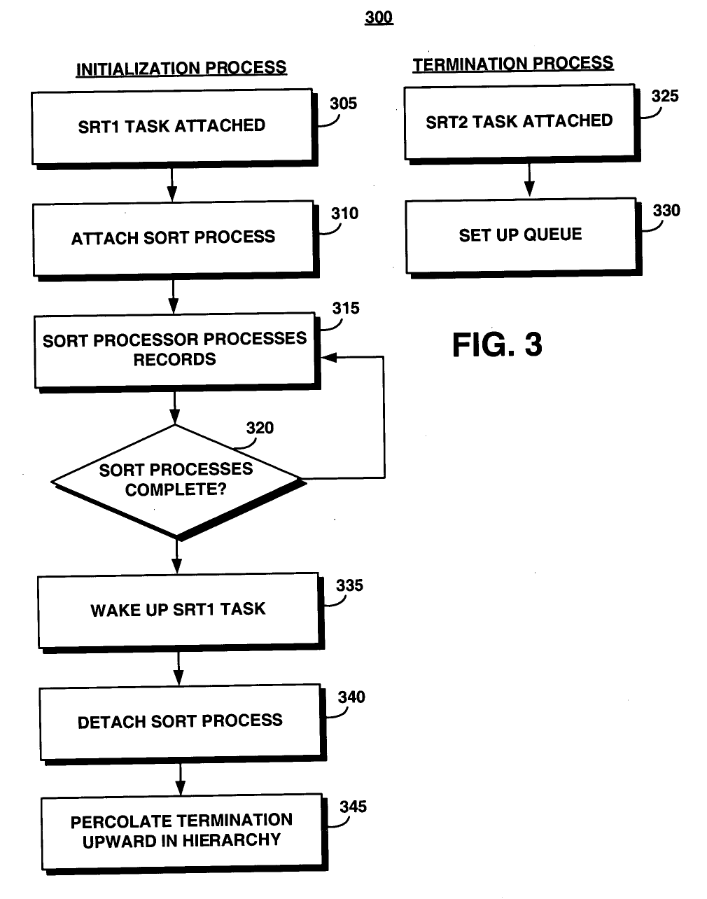

An overview of the initialization and termination method 300 is illustrated by the process flow chart of FIG. 3, with further reference to FIG. 2. A management task (SRT1 task 205) is attached at block 305 to oversee the start and stop of the sort processor 30 in the subordinate address space 40. SRT1 task 205 attaches the sort processor 30 as a sub-task with synchronous input exit 65 and synchronous output exit 70 at block 310. While the sub-ordinate SORT sub-task of the sort processor 30 is allowed to process the log records (block 315), SRT1 task 205 then enters a wait state (decision block 320). Concurrently to the process of blocks 305 through 315, a second management task (SRT2 task 210) is attached at block 325 to manage the asynchronous enqueue and dequeue buffering functions between the A/S server 10 and the synchronous input exit 65. A private queue 215 is also setup for the queuing process of input buffers 55, 60 at bock 330. When at decision block 320 the sub-ordinate SORT task of the sort processor 30 is complete, the SRT1 task 205 is “woken up” by the operating system (block 335). The SORT task is detached at block 340 and percolates termination upwards in the task hierarchy at block 345.

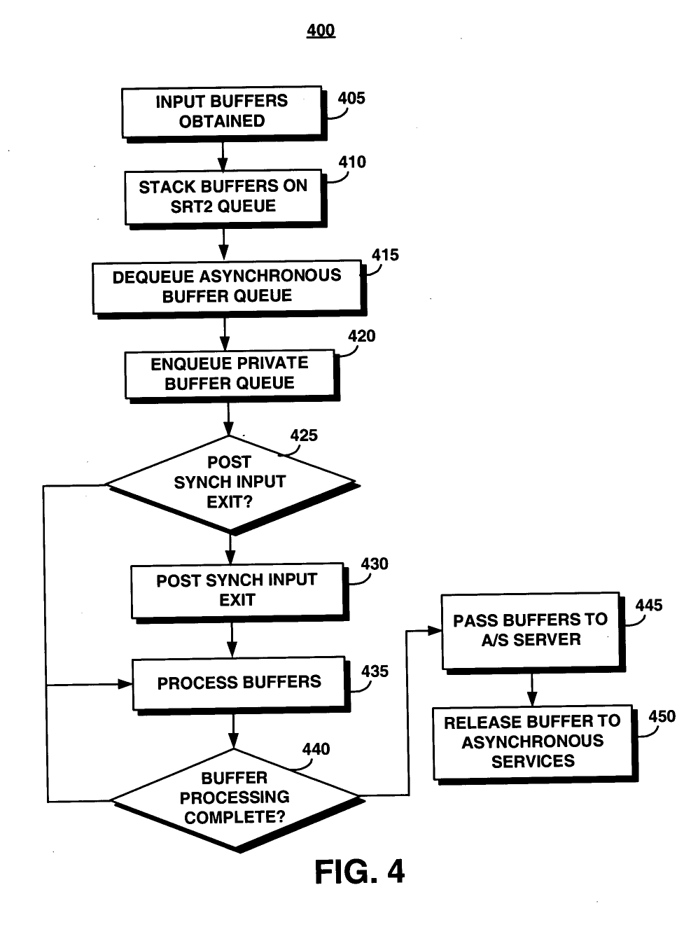

The method 400 of asynchronous input to a synchronous process is described by the process flow chart of FIG. 4. The input buffers 55, 60 are obtained by the synchronous input exit 65 at block 405 by means of a combination of services of the A/S server 10 and management of private queue 215. This enables the following processes to process in parallel and asynchronously while the A/S server 10 is unaware of the private buffer queue: the data pipe “off-loading” function, the private queue feeder function and the synchronous input exit dequeue-and-process function.

The input buffers 55, 60 are received via IMS pipe services in the subordinate address space 40 and stacked on the SRT2 sort input queue at block 410 by conventional asynchronous queuing services provided by A/S sever 10. The SRT2 task 210 dequeues the asynchronous buffer queue 225 at block 415 and enqueues it asynchronously at block 420 to a private buffer queue 215 for the synchronous input exit 65. If necessary at decision block 425, the SRT2 task 210 posts the synchronous input exit 65 at block 430.

The synchronous input exit 65 processes the buffers 55, 60 at block 435. If at decision block 440 the synchronous input exit 65 has completed processing a buffer 55, 60, buffers 55, 60 are passed to A/S server 10 for asynchronous queuing to the SRT2 task 210 at block 445. The SRT2 task 210 releases the buffer 55, 60 to asynchronous services at block 450. This combination of queuing services allows the feeding of the synchronous input exit 65 to be split asynchronously across the aforementioned parallel processes.

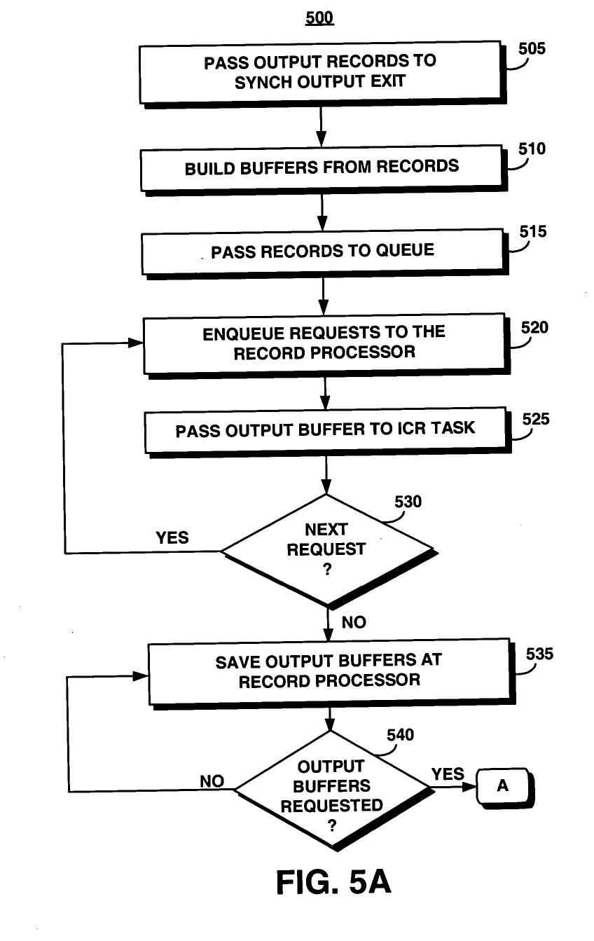

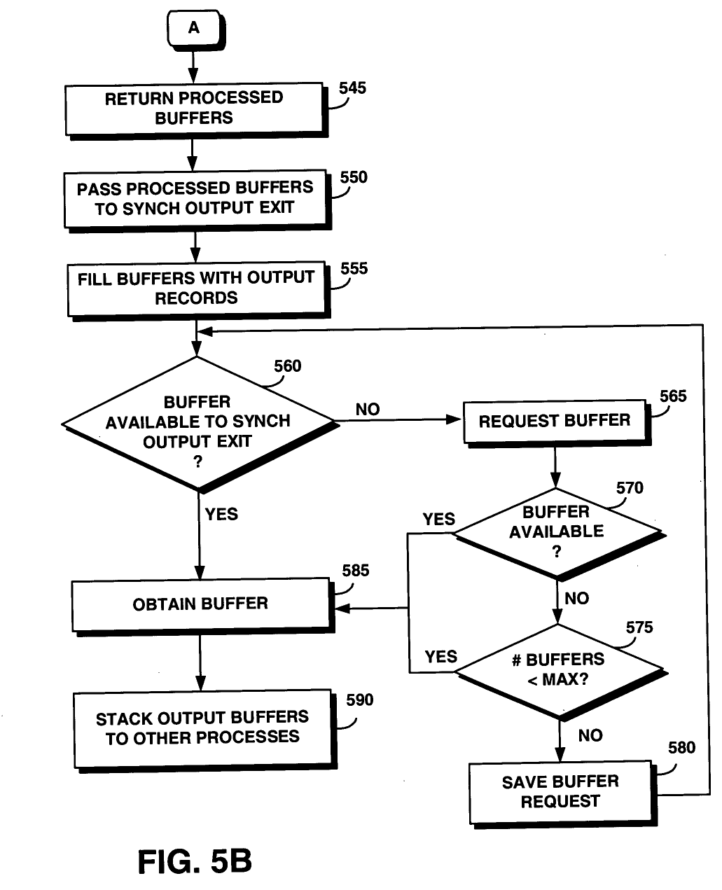

The method 500 of processing output records is illustrated by the process flow chart of FIG. 5 (FIGS. 5A, 5B). The output records are passed by the sort processor 30 to the synchronous output exit 70 at block 505. The synchronous output exit 70 builds buffers from the records at block 510 and then passes them to the data set restore input queue of the record processor 25 for processing at block 515.

The record processor 25 accepts synchronous buffers from the synchronous output exit 70 and saves them for requests by the Image Copy Restore (ICR) task 240. The ICR task 240 enqueues requests to the record processor 25 task that is asking for the next output buffer 75, 80 at block 520. The record processor 25 passes the output buffer 75, 80 to the ICR task 240 at block 525.

At decision block 530, the record processor 25 waits for the next request. The asynchronous ICR task 240 can process multiple input formats to merge the updates to a particular database record. Concurrently, the synchronous output exit 70 can continue to asynchronously build and stack output buffers 75, 80 to the record processor 25.

The output buffers 75, 80 are saved at the record processor 25 at block 535 until the ICR task 240 requests them. On every request for the next output buffer 75, 80 (decision block 540), the processed buffers (not shown) are returned by the ICR task 240 to the record processor 25 (block 545). These processed buffers are subsequently passed to the synchronous output exit 70 at block 550 to be filled with output records from sort processor 30 (block 555).

If the synchronous output exit 70 does not have a buffer available to be filled with output records from the sort processor 25 at decision block 560, the synchronous output exit 70 passes a request for an empty (or processed) buffer to the record processor 25 at block 565. This request for an empty (or processed) buffer is part of passing buffers to the record processor 25. If at decision block 570 the record processor 25 does not have a buffer available to be passed to the synchronous output exit 70, the maximum number of buffers in use is checked at decision block 575.

If a preset maximum number of buffers has been exceeded, the record processor 25 saves the request from the synchronous output exit 70 until the ICR task 240 returns a processed buffer. Otherwise, a buffer is obtained at block 585. The synchronous output exit 70 can asynchronously process output buffers 75, 80 while the ICR task 240 processes multiple input formats to merge the updates to a particular database record.

Concurrently, the record processor 25 asynchronously stacks output buffers 75, 80 to the other processes (block 590). The buffer maximum limit management allows this processing to take place without adversely affecting the resources available to other processing within the system.

It is to be understood that the specific embodiments of the invention that have been described are merely illustrative of certain applications of the principle of the present invention. Numerous modifications may be made to the system and method for facilitating data flow between synchronous and asynchronous processes invention described herein without departing from the spirit and scope of the present invention. Moreover, while the present invention is described for illustration purpose only in relation to synchronous sort processes, it should be clear that the invention is applicable as well, for example, to other embedded synchronous processes.

1. A method of facilitating data flow between a synchronous process and an asynchronous process, comprising:
converting an input asynchronous data flow from the synchronous process into a synchronous data flow;
processing the synchronous data flow by means of a synchronous task;
converting the processed synchronous data flow into an output asynchronous data flow; and
feeding the output asynchronous data flow to the asynchronous process.

2. The method according to claim 1, further comprising creating a synchronous buffer queue for the input asynchronous data flow.

3. The method according to claim 2, further comprising dequeuing a plurality of input buffers from the synchronous buffer queue.

4. The method according to claim 3, further comprising enqueuing the processed synchronous data flow on an asynchronous buffer queue.

5. The method according to claim 4, wherein processing the synchronous data flow comprises sorting the synchronous data flow.

6. The method according to claim 5, further comprising enqueuing the sorted synchronous data flow to a plurality of output buffers.

7. The method according to claim 6, further comprising synchronously filling the output buffers with the sorted synchronous data flow.

8. The method of claim 6, wherein the number of the output buffers is limited to a predetermined maximum value.

9. The method of claim 6, further comprising saving the sorted synchronous data flow in the output buffers at a record processor until the output buffers are requested by the asynchronous process.

10. The method of claim 1, further comprising saving the processed the synchronous data flow for an image copy restore task.

11. A computer program product having instruction codes for facilitating data flow between a synchronous process and an asynchronous process, the computer program product comprising:
a first set of instruction codes for converting an input asynchronous data flow from the synchronous process into a synchronous data flow;
a second set of instruction codes for processing the synchronous data flow by means of a synchronous task;
a third set of instruction codes for converting the processed synchronous data flow into an output asynchronous data flow; and
a fourth set of instruction codes for feeding the output asynchronous data flow to the asynchronous process.

12. The computer program product according to claim 11, further comprising a fifth set of instruction codes for creating a synchronous buffer queue for the input asynchronous data flow.

13. The computer program product according to claim 12, further comprising a sixth set of instruction codes for dequeuing a plurality of input buffers from the synchronous buffer queue.

14. The computer program product according to claim 13, further comprising a seventh set of instruction codes for enqueuing the processed synchronous data flow on an asynchronous buffer queue.

15. The computer program product according to claim 14, wherein the second set of instruction codes invokes a sort product to synchronously sort the synchronous data flow.

16. The computer program product according to claim 15, further comprising an eighth set of instruction codes for enqueuing the sorted synchronous data flow to a plurality of output buffers.

17. The computer program product according to claim 16, wherein the fourth set of instruction codes fills the output buffers with the sorted synchronous data flow.

18. The computer program product of claim 16, wherein the number of the output buffers is limited to a predetermined maximum value.

19. The computer program product of claim 16, further comprising a ninth set of instruction codes for saving the sorted synchronous data flow in the output buffers at a record processor until the output buffers are requested by the asynchronous process.

20. The computer program product of claim 11, wherein the third set of instruction codes saves the processed the synchronous data flow for an image copy restore task.

21. A system for facilitating data flow between a synchronous process and an asynchronous process, the system comprising:
an asynchronous to synchronous server for converting an input asynchronous data flow from the synchronous process into a synchronous data flow;
a synchronous task for processing the synchronous data flow; and
a synchronous to asynchronous server for converting the processed synchronous data flow into an output asynchronous data flow, and for feeding the output asynchronous data flow to the asynchronous process.

22. The system according to claim 21, further comprising a synchronous buffer queue for storing the input asynchronous data flow.

23. The system according to claim 22, further comprising a task for dequeuing a plurality of input buffers from the synchronous buffer queue.

24. The system according to claim 23, further comprising a task for enqueuing the processed synchronous data flow on an asynchronous buffer queue.

25. The system according to claim 24, wherein the synchronous task comprises a sorter that synchronously sorts the synchronous data flow

26. The system according to claim 25, further comprising a task for enqueuing the sorted synchronous data flow to a plurality of output buffers.

27. The system according to claim 26, wherein the synchronous to asynchronous server fills the output buffers with the sorted synchronous data flow.

28. The system of claim 26, wherein the number of the output buffers is limited to a predetermined maximum value.

29. The system of claim 26, wherein the synchronous to asynchronous server saves the sorted synchronous data flow in the output buffers at a record processor until the output buffers are requested by the asynchronous process.

30. The system of claim 21, wherein the synchronous to asynchronous server saves the processed the synchronous data flow for an image copy restore task.
